(19) United States
(12) Patent Application Publication
(10) Pub. No.: US 2013/0249932 A1
(43) Pub. Date: Sep. 26, 2013

(54) METHOD OF CONTROLLING A DISPLAY AND PORTABLE ELECTRONIC DEVICE

(71) Applicant: SONY MOBILE COMMUNICATIONS AB, Lund (SE)

(72) Inventor: Georg Siotis, Lund (SE)

(73) Assignee: SONY MOBILE COMMUNICATIONS AB, Lund (SE)

(21) Appl. No.: 13/848,446

(22) Filed: Mar. 21, 2013

Related U.S. Application Data
(60) Provisional application No. 61/613,631, filed on Mar. 21, 2012.

(30) Foreign Application Priority Data
Mar. 21, 2012 (EP) 12 002 003.7

(51) Int. Cl. G09G 5/02

(52) U.S. Cl. CPC G09G 5/02
USPC 345/589

(57) ABSTRACT

To control a display of a portable electronic device, data are retrieved which are indicative of a temperature variation over the display. The retrieved data are processed to generate a temperature chart for the display, the temperature chart being indicative of a temperature profile which is spatially varying in a display plane. The display is controlled in a spatially varying manner in accordance with the generated temperature chart.

### FIELD OF THE INVENTION

The invention relates to a method of controlling a display of a portable electronic device and to a portable electronic device. The invention relates in particular to a method and to a portable electronic device in which temperature data associated with the display are sensed.

### BACKGROUND OF THE INVENTION

Optical output units configured as displays are widely used in portable electronic devices. The heat generated by components of the portable electronic device, such as a processor, graphics card, memory controller or memory, may give rise to a temperature increase of the display. A variety of displays is configured such that temperature changes may lead to temperature-induced color alterations perceived by a user. Even when the display is controlled such that the same color value is output at the same pixel, the color as perceived by the user may appear different depending on the temperature of the display.

Temperature-induced color variations may be distractive to the user and may affect the quality of the user interface. One approach to address such temperature-induced color alterations would be to measure one temperature value in proximity to the display and perform color compensation based on the sensed temperature value. Such an approach would correct temperature-induced color alterations in the same way over the display, and may not be sufficient to mitigate the problems associated with temperature-induced color alterations when the temperature varies over the display.

Problems associated with temperature-induced color variations may become even more relevant with decreasing thicknesses of portable electronic devices. For illustration, electronic devices which have a screen which extends essentially throughout one of the major faces of the device housing, and which have a thickness between a few centimeters and less than a centimeter, may require at least some of the electrical components which may generate significant amounts of heat to be positioned in proximity to the display. One approach to address local heating may consist in using members which spread heat evenly over the display and/or which provide heat insulation between processors and display. However, such members would add to the installation space and weight, which may be undesirable in handheld devices. Not all vendors may be willing to use dedicated members for heat spreading and/or heat insulation. Realistic implementations of such members may not be capable of reducing temperature peaks at hot spots on the display. Therefore, temperature-induced color alterations may still be a problem.

### SUMMARY OF THE INVENTION

Accordingly, there is a need for a method of controlling a display of a portable electronic device and for a portable electronic device which addresses at least some of these shortcomings. In particular, there is a need for such a method and portable electronic device which addresses temperature-induced color alterations which are brought about by local heating or “hot spots” in the portable electronic device.

According to an embodiment, a method of controlling a display of a portable electronic device is provided. The method comprises retrieving data which are indicative of a temperature variation over the display. The method comprises processing the retrieved data to generate a temperature chart for the display, the temperature chart being indicative of a temperature profile which is spatially varying in a display plane. The method comprises controlling the display in a spatially varying manner in accordance with the generated temperature chart.

The temperature chart may be a data structure indicative of a temperature profile which is spatially varying in the display plane. The temperature chart may comprise or may be a two-dimensional array of temperature values.

Controlling the display may comprise applying a color correction to compensate for temperature-induced color alterations, the color correction being spatially varying in accordance with the generated temperature chart.

The color correction may be selected such that when an image having the same color value at a first pixel and a second pixel is output over the display, the color at the first pixel and the second pixel is perceived to be the same even when the temperature of the display is different at the first pixel and the second pixel. The color correction may be selected such that when an image having the same color value at a first pixel and a second pixel is output over the display, the perceived color as determined by the gamma curve(s) of the display is the same even when the temperature of the display is different at the first pixel and the second pixel.

The color correction may be applied to image data to generate temperature-compensated image data based on both the generated temperature chart and the image data. The display may be controlled to output the temperature-compensated image data.

The retrieved data indicative of the temperature variation may comprise temperature data for a plurality of areas of the display, the plurality of areas being offset from each other parallel to the display plane.

A plurality of temperature sensing elements may be arranged on the display, with each one of the temperature sensing elements being arranged in one of the plurality of areas. The plurality of temperature sensing elements may define an array of temperature sensing elements. The array may be a regular array, such as a rectangular arrangement of temperature sensing elements. The array may define a matrix configuration of measurement points, defining a two-dimensional arrangement of measurement points for sensing a temperature variation over the display.

The array of temperature sensing elements may comprise an indium tin oxide (ITO) layer. Elements of the ITO layer may be used in a Wheatstone bridge configuration to provide an analog signal which depends on the temperate at the respective measurement point. Other configurations may be used, such as an array of thermistors formed from graphene, carbon nanotubes, or another material which is transparent such that it can be positioned on a light emitting surface of the display. The array of temperature sensing elements may provide analog signals which are processed to ultimately generate the temperature chart. The array of temperature sensing elements may be comprised by a touch sensor panel, a proximity sensor panel or a force sensor overlaid onto the display.

Alternatively or additionally, the array of temperature sensing elements may include thermistors which are positioned at a rear side of the display, i.e. at the side opposite to the light emitting side. The thermistors may respectively be configured as thin film thermistors. The thermistors may each be thermally coupled to the display.

The temperature chart may be determined by interpolation based on the output signals of the array of temperature sensing elements. The output signals of the temperature sensing elements may be processed to determine the temperatures at the locations of the temperature sensing elements. The temperature chart may be determined by interpolation between these temperatures, using gradient interpolation techniques or other interpolation techniques which are based on the locations of the temperature sensing elements and the respectively sensed temperatures.

The retrieved data indicative of the temperature variation may comprise temperature data for at least one region of the display and information on a topology of the portable electronic device.

The information on the topology may include information on a position of at least one electronic component of the portable electronic device relative to the display.

Temperature data for a plurality of regions of the display may be determined based on the information on the topology of the portable electronic device and the temperature data for at least one region of the display.

The temperature chart may include an estimate for a temperature at another region of the display for which no temperature data are retrieved. The estimate may be determined by interpolating the temperature data for the plurality of regions. Various interpolation schemes may be used, such as linear interpolation, non-linear interpolation, gradient based interpolation, or splines, without being limited thereto.

The retrieving and processing operations may be repeated after a time interval to generate an updated temperature chart. The color correction may be dynamically adjusted in accordance with the updated temperature chart.

The method may further comprise monitoring a workload of at least one electronic component of the portable electronic device. The time interval may be adjusted based on the workload.

The display may have a plurality of pixels, each pixel having a color value. The color correction which is applied to the color value of a pixel may be set based on a value of the temperature chart for the respective pixel.

The method may further comprise sensing, by a thermistor array, the data indicative of the temperature variation.

According to another embodiment, a portable electronic device comprises a display and a controller coupled to the display. The controller is configured to retrieve data which are indicative of a temperature variation over the display. The controller is configured to process the retrieved data to generate a temperature chart for the display, the temperature chart being generated so as to be indicative of a temperature profile which is spatially varying in a display plane. The controller is configured to control the display in a spatially varying manner in accordance with the generated temperature chart.

The portable electronic device may further comprise a thermistor array configured to sense the data indicative of the temperature variation. The controller may be coupled to the thermistor array to retrieve the data indicative of the temperature variation from the thermistor array.

The controller may monitor a workload of at least one electronic component of the portable electronic device. The controller may be configured to adjust a time interval based on the workload, and to generate an updated temperature chart after the time interval.

The controller may be configured to perform the method of any one aspect of embodiment.

The portable electronic device may comprise a mobile communication interface. The portable electronic device may be a cellular phone, a personal digital assistant, a mobile computer, or another handheld device.

The method and the portable electronic device of embodiments generates a temperature chart indicative of the temperature variation over the display, i.e. the temperature variation as a function of the two coordinates in the display plane, and uses this information to perform a spatially resolved color correction. This allows thermally induced local color alterations to be compensated. Even when local hot spots are created where pronounced heating of the display occurs locally, the resultant temperature-induced color alterations may be mitigated.

It is to be understood that the features mentioned above and features yet to be explained below can be used not only in the respective combinations indicated, but also in other combinations or in isolation, without departing from the scope of the present invention. Features of the above-mentioned aspects and embodiments may be combined with each other in other embodiments.

### BRIEF DESCRIPTION OF THE DRAWINGS

The foregoing and additional features and advantages of the invention will become apparent from the following detailed description when read in conjunction with the accompanying drawings, in which like reference numerals refer to like elements.

FIG. 1 is a top view of a portable electronic device of an embodiment.

FIG. 2 shows a block diagram representation of the portable electronic device of an embodiment.

FIG. 3 is a schematic representation of a temperature variation over the display of the portable electronic device of an embodiment.

FIG. 4 is a plan view of the display for illustrating the generation of a temperature chart for a display of a portable electronic device of an embodiment.

FIG. 5 is a plan view of the display for illustrating the generation of a temperature chart for a display of a portable electronic device of another embodiment.

FIG. 6 shows image data and a temperature chart for explaining processing operations performed by a controller of a portable electronic device of an embodiment.

FIG. 7 is a flow chart of a method of an embodiment.

FIG. 8 is a flow chart of a method of another embodiment.

FIG. 9 shows a block diagram representation of the portable electronic device of another embodiment.

FIG. 10 shows image data and a temperature chart for explaining processing operations performed by a controller of a portable electronic device of an embodiment.

### DETAILED DESCRIPTION OF PREFERRED EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations, and elements illustrated in the drawings are not necessarily shown to scale. Rather, the various elements are represented such that their function and general purpose become apparent to a person skilled in the art. Any connection or coupling between functional blocks, devices, components or other physical or functional units shown in the drawings or described herein may also be implemented by an indirect connection or coupling. Functional blocks may be implemented in hardware, firmware, software or a combination thereof.

The features of the various embodiments may be combined with each other, unless specifically noted otherwise.

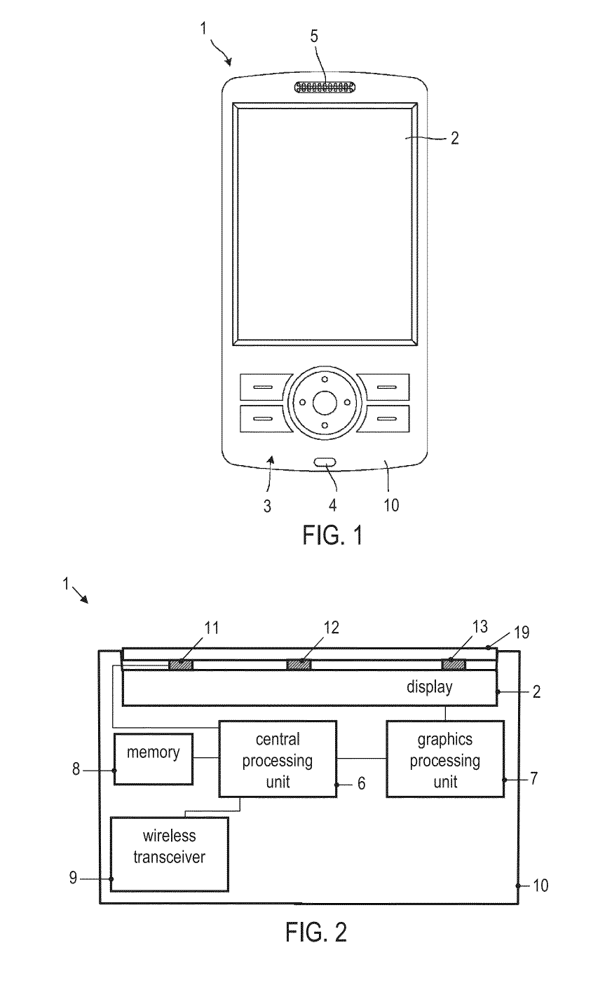

FIG. 1 is a front view of a portable electronic device 1 of an embodiment. FIG. 2 is a schematic block diagram representation of the portable electronic device 1. The portable electronic device 1 includes a display 2. A proximity-sensing user interface 19 may be overlaid on the display 2. The portable electronic device 1 may include additional input interface components. For illustration, navigation and control keys 3 configured as hard keys may be provided on a housing 10 of the portable electronic device. In other implementations, the display 2 may extend substantially throughout a major face of the housing 10, and control and navigation functions may be realized through the display 2. The display 2 may be a liquid crystal display, a light emitting diode (LED) display, an organic light emitting diode (OLED) display, or another display. The display 2 may be a two-dimensional display or may be configured as a stereoscopic or autostereoscopic display which provides perspective effects.

The portable electronic device 1 has a controller. The controller may include one or plural processors. In the illustrated implementation, the controller includes a central processing unit 6 and a graphics processing unit 7. The portable electronic device 1 may further comprise a memory 8 storing instruction code for the central processing unit 6. A wireless transceiver 9 may be coupled to the central processing unit 7. The wireless transceiver 9 may be configured for wireless communication under a wireless communication standard, such as GSM, 3GPP, UMTS, LTE, WLAN, or other communication standards. The central processing unit 6 may control the wireless transceiver 9 so as to enable wireless voice and/or data communication. The central processing unit 6 may be coupled to a microphone 4 and a loudspeaker 5 for voice communication.

The portable electronic device 1 is configured such that the controller retrieves data which are indicative of a temperature variation over the display 2, i.e. which are indicative of a temperature variation as a function of the two coordinates which span the display surface. The controller processes the data and generates a temperature chart which is indicative of a temperature profile varying in a display plane, i.e. a temperature profile which varies as a function of the two coordinates which span the display surface. The controller controls the display in a spatially varying manner in accordance with the generated temperature chart. The controller may in particular apply a color correction to compensate for temperature-induced color variations across the display, the color correction being spatially varying in accordance with the temperature chart.

The temperature chart may be a data structure indicative of a temperature profile which is spatially varying in the display plane. The temperature chart may comprise or may be a two-dimensional array of temperature values, for example.

In order to generate the temperature chart which provides a two-dimensional array of temperature values over the display 2, the portable electronic device 1 may include an array of temperature sensing elements. For illustration, temperature sensing elements 11-13 may be arranged on a light-emitting surface of the display 2 and may be in thermal contact with the display 2. The temperature sensing elements 11-13 may be formed from a transparent material, such as indium tin oxide (ITO), graphene, carbon nanotubes, or another transparent film having a resistance which changes as a function of temperature. A Wheatstone bridge configuration may be used for each temperature sensing element 11-13 to determine the temperature. An analog signal provided by the temperature sensing elements 11-13 may be processed by the controller of the portable electronic device 1 or a dedicated processor of a temperature sensing device which includes the array of temperature sensing elements 11-13. The data obtained by processing the signals of the temperature sensing elements 11-13 is processed further to generate a temperature chart, which may also include information on estimated temperatures at locations interposed between the temperature sensing elements 11-13. Interpolation techniques may be used to generate the temperature chart. The temperature chart may be generated as a two-dimensional data array indicative of the temperature profile over the display.

A wide variety of temperature sensing devices coupled to the controller of the portable electronic device 1 may be used so as to allow the temperature chart to be generated. For illustration, thin film thermistors may also be positioned at a rear side of the display 2 which faces away from the light emitting surface of the display 2. The array of temperature sensing elements may be a regular array, but does not need to be a regular array. For illustration, a density of temperature sensing elements may be greater in some regions of the display 2 where a hot spot is more likely to occur, due to the proximity of the central processing unit 6, of the graphics processing unit 7, of the memory 8, or another component of the portable electronic device 1 which is known to generate a substantial amount of heat under at least some operation conditions.

The controller of the portable electronic device 1 may utilize additional information to generate the temperature chart based on sensed temperatures. For illustration, information on the topology of the portable electronic device 1 may be utilized. Such information specifies under which areas of the display 2 a component of the portable electronic device 1 is located which produces substantial heat. The controller of the portable electronic device 1 may take into account characteristic local temperature profiles which occur in proximity to a local hot spot, due to heat transport through the display 2, and may generate the temperature chart in accordance with the topology information of the portable electronic device 1.

The controller of the portable electronic device 1 may perform various operations to implement a color correction. When an image is to be output, the controller may determine a color value of pixels in the image data. The controller may use the temperature chart to identify a temperature of the display at the location of the respective pixel. The controller may set the color correction based on at least the temperature. The color correction may include adding an offset value to the color value of the pixel, the offset value being set based on the temperature of the display at the respective pixel. The color correction may include multiplication of the color value of the pixel by a multiplicative factor, which is set based on the temperature of the display at the respective pixel. The color correction may include determining, based on the display's gamma curve, how the color value of the pixel is to be altered based on the temperature of the display at the respective pixel. The color correction may be based on both the color value of the pixel in the image data and the temperature of the display at the respective pixel, as indicated by the generated temperature chart. When there are plural color channels, the color correction may be applied in each one of the color channels.

Any one of a variety of color correction schemes may be used. Examples for such color correction schemes which compensate temperature-induced color variations are described in US 2010/0289811 A1. While the controller of the portable electronic device 1 of embodiments may use such color correction schemes for determining how a color value is to be altered based on temperature, it will be appreciated that the controller of the portable electronic device 1 accommodates spatial variations in temperature over the display, rather than using merely one global temperature offset for the display as a whole.

The controller of the portable electronic device 1 may perform the color correction in a pixel-wise fashion to generate modified image data which are then supplied to the graphics processing unit 7. The data which indicate how, for a given local temperature, a color value is to be adjusted may be stored in the memory 8 and may be retrieved from the memory 8 by the controller of the portable electronic device 1.

The controller of the portable electronic device 1 may repeat the generation of the temperature chart after a time interval. The color correction may be dynamically adjusted to temperature changes. The time interval may be adjusted based on a workload of the central processing unit 6, of the graphics processing unit 7, and/or the memory 8, such that the time interval decreases as the workload of the respective component increases. Local heating which results from high workload of the central processing unit 6, of the graphics processing unit 7, and/or the memory 8 may thereby be compensated with a short response time.

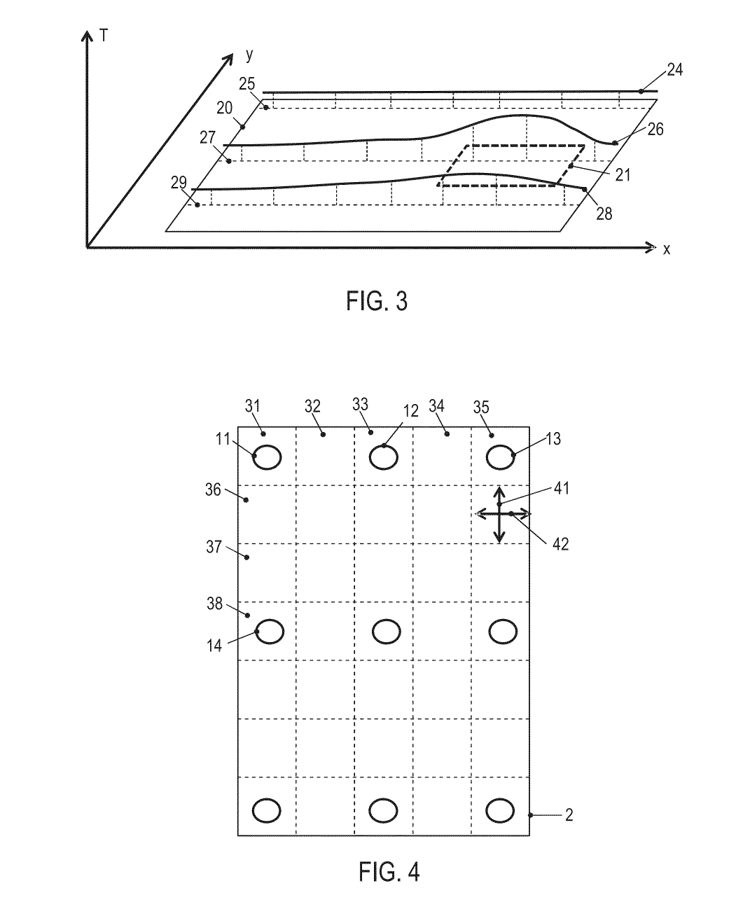

The operation of the portable electronic device 1 will be explained in more detail with reference to FIGS. 3-10.

FIG. 3 is a schematic view illustrating local heating of the display 2 of the portable electronic device 1. The display 2 has a display plane 20 in which the display 2 extends. A component of the portable electronic device 1 which produces a significant amount of heat in at least some operating conditions is disposed below an area 21 of the display plane 20. The component disposed below the area 21 may be the central processing unit 6, the graphics processing unit 7, or the memory 8, for example. Local heating may occur in the area 21. While the heat may be distributed across the display as time passes by thermal transport, a local hot spot may still exist in area 21.

The temperature profile is schematically indicated for three columns of the display. A temperature profile 24 measured along a column 25 which is remote from the area 21 may be essentially flat and may be comparable to ambient temperature. A temperature profile 26 measured along a column 27 which passes through the area 21 may exhibit an elevated temperature. The local temperature increase is due to the local heating which is brought about by the component of the portable electronic device 1 disposed below the area 21. A temperature profile 28 measured along a column 29 which is offset from the area 21, but adjacent to the area 21, may also exhibit a local temperature increase. The local temperature increase is due to the local heating which is brought about by the component of the portable electronic device 1 disposed below the area 21, possibly in combination with heat transfer in the portable electronic device 1.

The temperature variation over the display has the effect that, in a conventional device, a pixel in area 21 and a pixel in column 25 may be perceived by the user to have different colors, even when the color values for the pixels are identical. Such effects may be quantified for the respective display 2 by the gamma curve(s) of the display. In portable electronic devices and methods of embodiments, the temperature variation is taken into account to perform a color correction which compensates at least a portion of temperature-induced color alterations.

FIG. 4 is a plan view of the display 2 of the portable electronic device of an embodiment. A regular array of temperature sensing elements 11-14, schematically shown as closed circles, is provided. Output signals of the temperature sensing elements 11-14 are processed to determine temperatures at the positions of the temperature sensing elements 11-14.

The controller of the portable electronic device 1 processes the data retrieved from the temperature sensing elements 11-14 to determine a temperature chart which indicates the temperature variation in the display plane. A regular array of regions 31-38 may be defined, and the controller may determine a temperature value for each one of the regions 31-38 based on the data retrieved from the temperature sensing elements 11-14. Interpolation techniques, such as gradient-based interpolation or mean value computations, may be used to determine the temperature chart based on the output of the temperature sensing elements 11-14. For regions 31, 33, 35 and 38 which are provided with a temperature sensing element, the sensed temperature may be used to generate a corresponding entry in the temperature chart. For other regions 32, 34, 36 and 37 which are not provided with a temperature sensing element, the entry in the temperature chart may be estimated based on the temperatures sensed by the temperature sensing elements. Interpolation techniques may be used to derive temperature values for the other regions 32, 34, 36 and 37, and the estimates are written into the temperature chart. Other techniques may be used to generate the temperature chart. For illustration, a least square fit may be made to the sensed temperatures to determine the temperature chart. The fit function may take into account physical constraints and/or the topology of the portable electronic device 1.

Each one of the regions 31-38 may have a height 41 which corresponds to a first number of pixels and a width 42 which corresponds to a second number of pixels. The regions 31-38, which are used to compute the temperature chart, may each comprise a plurality of pixels. The size of the regions 31-38 may also be selected such that each region corresponds to one pixel of the display only.

Other arrangements of the temperature sensing elements and/or other configurations of the regions used to determine the temperature chart may be used.

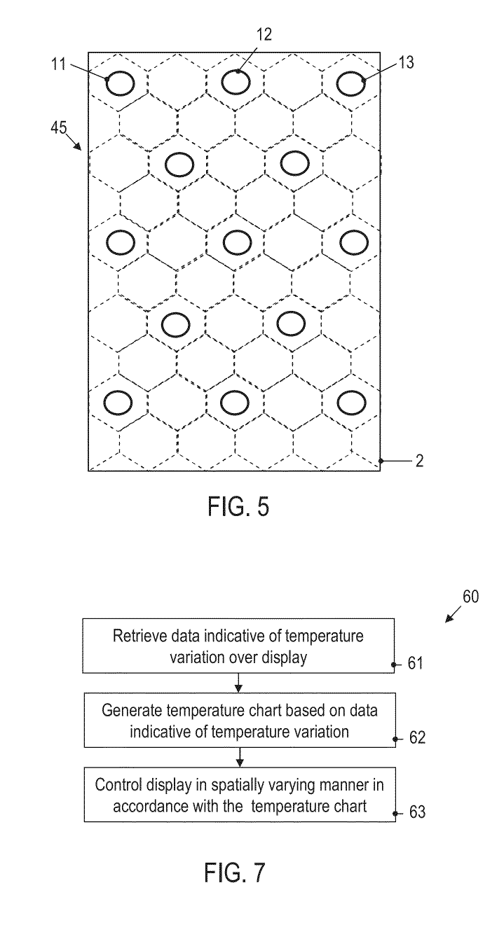

FIG. 5 is a plan view of the display 2 of the portable electronic device of another embodiment. A regular array of temperature sensing elements 11-13, schematically shown as closed circles, is provided. Output signals of the temperature sensing elements 11-13 are processed to determine temperatures at the positions of the temperature sensing elements 11-13. A honeycomb lattice defining a plurality of regions 45 is used to determine the temperature chart for the display. As described with reference to FIG. 4, interpolation techniques and/or fitting may be used to estimate the temperature at a cell of the honeycomb lattice which does not have a dedicated temperature sensing element, based on the output signals of the temperature sensing elements 11-13.

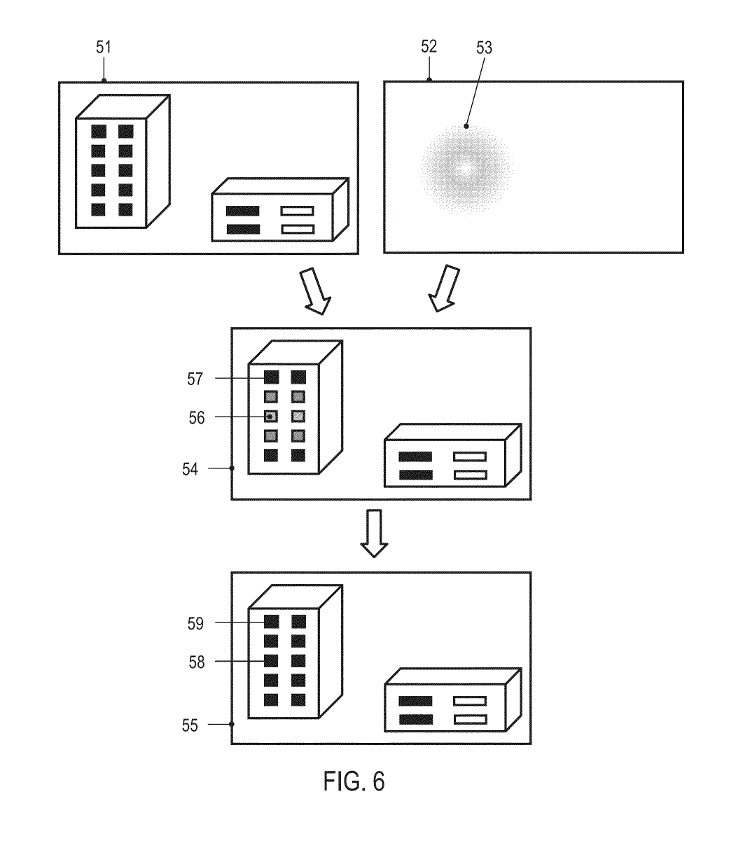

FIG. 6 is a schematic representation for explaining the processing performed by the controller of the portable electronic equipment 1. The controller uses image data 51 and a temperature chart 52 for controlling the display 2 of the portable electronic device. The temperature chart 52 provides information on a temperature profile of the display which varies in a display plane. The temperature chart 52 is schematically shown as a grayscale image, with local heating occurring in a region 53.

The controller generates modified image data 54 based on the image data 51 and the temperature chart 52. The controller may apply a color correction to generate the modified image data 54. This may be done in a pixel-wise fashion. Color values of pixels of the image data may be altered based on the temperature chart 52. The controller may perform any one of a variety of techniques to generate the modified image data 54. For illustration, additive of subtractive offsets may be used to determine a color value of a pixel in the modified image data 54, based on the color value of the same pixel in the image data 51 and the temperature value indicated by the temperature chart 52 for this pixel. Alternatively or additionally, multiplicative factors may be used to modify the color values. The change in color value of a pixel may be set based on the gamma curve of the display. For color images with several color channels, where the color of each pixel is encoded in a tuple of numerical values such as a 3-tuple for RGB or a 4-tuple for CMYK, the corresponding temperature-based correction may be made for each color channel.

The color correction has the effect that pixels 56 and 57, which have the same color values in the image data 51, may have different color values in the modified image data 54 when the temperatures indicated by the temperature chart 52 are different for the pixels 56 and 57.

The image as perceived by a user is schematically shown at 55. The controller of the portable electronic device sets the color values of pixels in the modified image data 51 such that, owing to the temperature variation over the display, the pixels 58 and 59 as seen by an observer are perceived to have the same color. The difference in color values of pixels 56 and 57 in the modified image data is set such that it is balanced by the temperature-induced color alteration when outputting the modified image data. In the resultant image 55 perceived by the user, temperature-induced color alterations of the original image data 51 are reduced or eliminated. The local, temperature-dependent modification of the image data is set such that the modification made to color values of pixels in the modified image data 54 will be balanced by the temperature-induced color alteration when outputting the modified image data.

The controller may set the value of a pixel 56 in the modified image data based on the Gamma curve of the display. The controller may determine which color value, when output at a pixel having the temperature indicated by the temperature chart, will give rise to a perceived color which corresponds to the color defined for the pixel by the original image data 51. A two-dimensional color correction map may be generated for each color channel which may be used to generate the modified image data 54 from the image data 55, e.g. by adding temperature-dependent offsets, multiplying color values by a temperature-dependent factor, performing a table lookup based on the local temperature and/or analyzing a Gamma curve of the display based on the local temperature.

FIG. 7 is a flow chart of a method 60 of an embodiment. The method 60 may be performed by the portable electronic device of an aspect or embodiment.

At 61, data indicative of a temperature variation over the display are retrieved. The data indicate temperatures at plural positions on the display which are offset from each other in the display plane. The data may be retrieved from a temperature sensor device which includes an array of temperature sensing elements. The array of temperature sensing elements may be formed as an ITO layer or an array of thin film thermistors.

At 62, the data are processed and a temperature chart is generated. The temperature chart defines a temperature profile which varies as a function of position on the display. The temperature chart may be a two-dimensional array. The temperature chart includes estimates for temperatures at positions on the display at which no temperature sensing is performed. The estimates may be obtained using interpolation techniques, such as gradient based interpolation or mean value calculations. The temperature chart may be a two-dimensional array of temperature values which has a number of entries that is greater than a total number of temperature sensing elements which locally sense temperature.

At 63, the display is controlled in a spatially varying manner in accordance with the determined temperature chart. A spatially varying color correction may be applied. For each one of a plurality of regions of the display, a color correction performed for pixels located in the region may be set based on the temperature value indicated by the temperature chart for the respective region.

Steps 61 and 62 may be repeated, to dynamically update the temperature chart. Steps 61 and 62 may be repeated after a time interval. The temperature chart is continued to be used to perform the color correction for any image that is to be output, as long as the temperature chart is overwritten by an updated temperature chart. The time interval may be adjusted based on a workload of at least one component or of a plurality of components of the portable electronic device. Alternatively or additionally, the data indicative of the temperature variation retrieved at 61 may be monitored in a continuous or quasi-continuous manner. Step 62 may be repeated when a change in temperature variation is detected which exceeds a threshold.

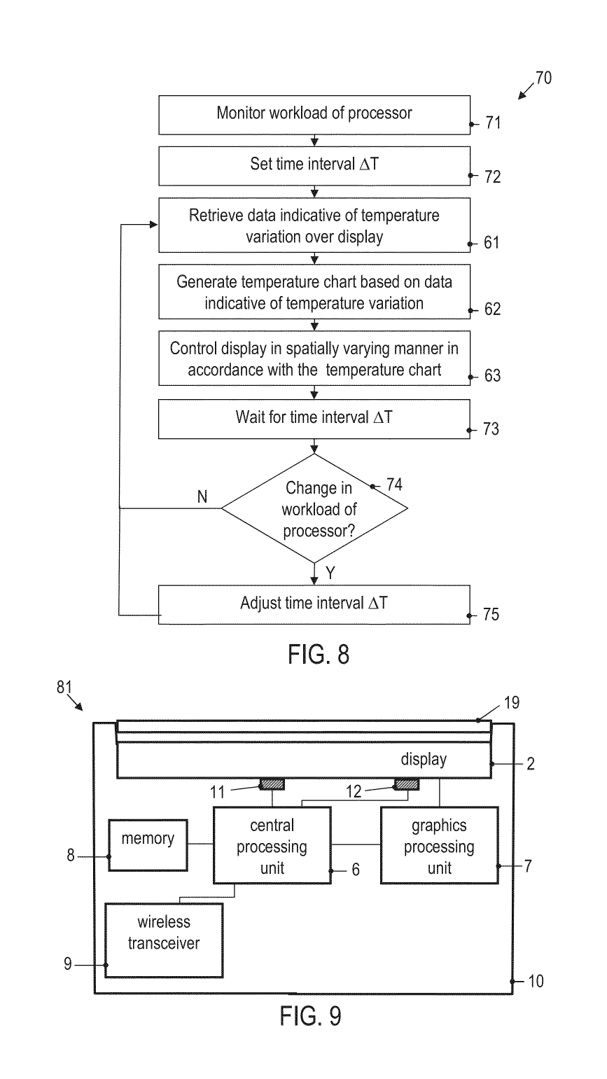

FIG. 8 is a flow chart of a method 70 of an embodiment. The method 70 may be performed by the portable electronic device of an aspect or embodiment. In the method 70, a time interval at which the temperature chart is re-computed is adjusted based on a workload of a component of the portable electronic device. While exemplified in the context of a time interval which is adjusted based on the workload of a processor, such as the central processing unit 6 or the graphics processing unit 7, the time interval may alternatively or additionally be adjusted based on a workload of a memory, a memory controller, a wireless communication circuit, or other components of the portable electronic device 1.

At 71, a workload of a processor of the portable electronic device is monitored. The workload may indicate a percentage of a maximum workload of the processor. At 72, a time interval is set based on the monitored workload. At 61-63, the processing explained with reference to the method 60 of FIG. 6 may be performed.

At 73 and 74, after a wait time which corresponds to the time interval set at 72, it is determined whether the workload of the processor has changed. A threshold comparison may be performed to determine whether the time interval is to be adjusted. If the workload of the processor has not changed at all, or has changed by less than a threshold, the method may revert to 71. Steps 61-63 may be repeated after the time interval previously set.

If the workload of the processor has changed, or has changed by at least the threshold value, the method continues at 75. At 75, the time interval is adjusted. The time interval may be adjusted such that the time interval decreases when the workload of the processor increases, and vice versa. Thereby, the rate at which the temperature chart is updated may be increased when the processor is likely to produce more heat, and may be decreased when the processor is likely to produce less heat. Spurious re-computation of the temperature chart may be avoided in operation conditions in which the temperature chart is unlikely to change. Vice versa, more rapid updating of the color correction based on the temperature chart may be realized in operation conditions in which the temperature chart is likely to change more rapidly.

The temperature chart used as a basis for controlling the display in a spatially varying manner may be generated using temperature data from a plurality of regions of the display as input. Other information may be used in addition or as an alternative. For illustration, the positions of processors, memories, wireless transceivers or other components of the portable electronic device which may give rise to local heating of the display are known. This information on the topology of the portable electronic device may be used when generating the temperature chart. Alternatively or additionally, a temperature profile over the display may be determined from a measured temperature in combination with information on the topology of the portable electronic device.

FIG. 9 illustrates a portable electronic device 81 of another embodiment. In the portable electronic device, temperature sensing elements 11, 12 are provided at a rear side of the display 2. The positions of the temperature sensing elements 11, 12 are selected based on the position of components which may likely generate hot spots on the display. A temperature sensing element 11 may be attached to the display 2 to sense a local temperature of the display 2 at a lateral position, measured transverse to a normal vector of the display 2, which overlaps with the lateral position of the central processing unit 6. Another temperature sensing element 12 may be attached to the display 2 to sense a local temperature of the display 2 at a lateral position which overlaps with the lateral position of the graphics processing unit 7. Other temperature sensing elements may be provided, to sense the temperature of the display in proximity to the memory 8 and/or in proximity to the wireless transceiver 9. The temperature sensing elements may respectively be configured as thin film thermistors.

The controller of the portable electronic device 81 may process the output signals of the temperature sensing elements 11 and 12. The local temperatures sensed by the temperature sensing elements 11 and 12 may be combined with additional information such as lateral dimensions of the central processing unit 6 or other processors, the thermal conductivity of the display 2, or characteristic temperature profiles which are known to occur in response to local heating of the display. Alternatively or additionally, interpolation may be used to determine entries of the temperature chart at positions which are offset from the positions of the temperature sensing elements 11 and 12.

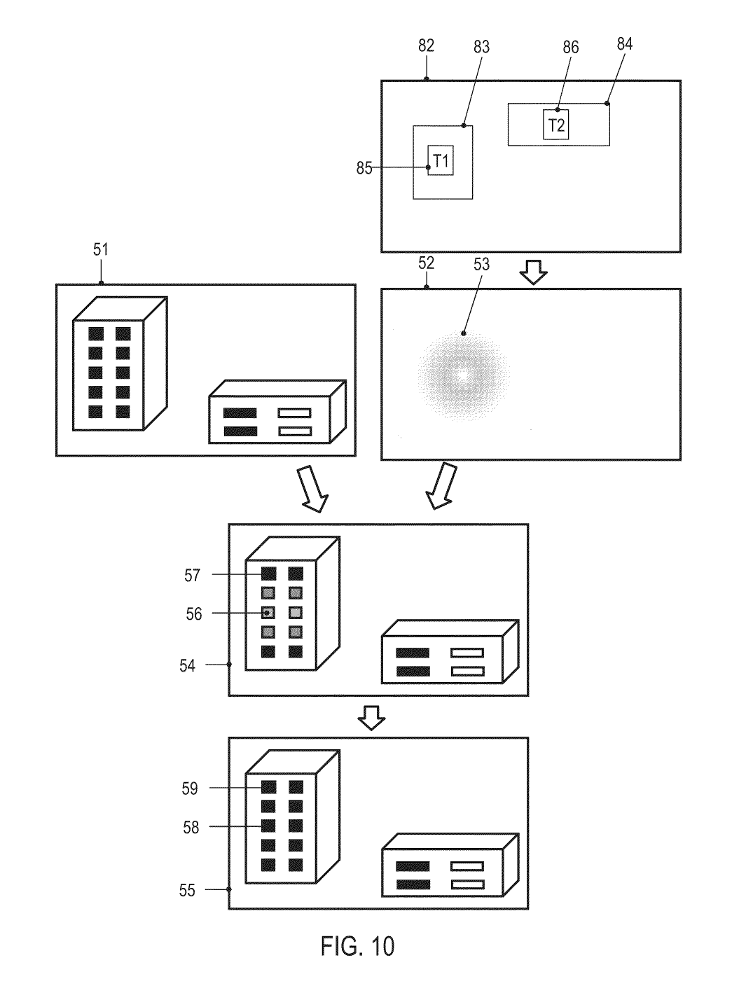

FIG. 10 is a schematic representation for explaining the processing performed by the controller of the portable electronic equipment 81. The controller uses image data 51 and a temperature chart 52 for controlling the display 2 of the portable electronic device. The controller generates the temperature chart 52 based on temperatures sensed in one or plural regions 85 and 86 of the display. The controller utilizes information on the topology of the portable electronic device, schematically indicated at 81, to compute the temperature chart 52. The information on the topology of the portable electronic device may be a map of components which act as potential heat sources for the display. For illustration, information on the position and/or dimension of areas 83 and 84 below which a processor, a memory or a wireless communication circuit of the portable electronic device are arranged may be combined with the temperatures sensed in regions 85 and 86. The resulting temperature chart 52 may be utilized to generate modified image data 54, as explained with reference to FIG. 6. In the modified image data 54, color values of pixels are adjusted to compensate for temperature-induced color alterations.

Methods and portable electronic devices of embodiments have been described in detail with reference to the drawings. Modifications may be implemented in other embodiments.

For illustration, a control process of a display which is performed in accordance with a determined temperature chart is not limited to performing a color correction which reduces temperature-induced artifacts, but may alternatively or additionally be employed to control a lenticular sheet or a parallax barrier in stereoscopic or autostereoscopic displays. For illustration, a set of layers which form a lenticular sheet array or a parallax barrier of an autostereoscopic display may be controlled in accordance with the temperature chart. This allows changes in refractive index caused by local temperature variations to be compensated.

For further illustration, while dedicated temperature sensing elements may be provided which are disposed on a light emitting surface or on a rear side opposite to the light emitting surface of the display, the temperature sensing elements may be integrated with other components of the portable electronic device. For illustration, the temperature sensing elements may be integrated into a force sensing arrangement or into a touch sensor panel of the portable electronic device.

For further illustration, while the temperature chart may be generated by interpolation based on temperature values sensed at a grid of positions, the temperature chart may also be generated based on fitting using pre-determined fit curves, by using sensed temperature values in association with information on the topology of the portable electronic device, or by a combination of such techniques.

For further illustration, while embodiments have been described in which modified image data are generated in a pixel-wise fashion, a color correction based on the temperature chart may also be performed by a graphics processing unit which works on vectorized graphics.

For further illustration, the temperature chart may be used to identify image regions of an image in which temperature correction is to be performed. The color correction may be limited to certain regions of the image, which are selected based on the temperature chart. For illustration, color correction may be limited to regions in which the local temperature as indicated by the temperature chart differs from an average display temperature by more than a threshold.

Examples for portable electronic equipments which may be configured as described herein include, but are not limited to, a cellular phone, a cordless phone, a personal digital assistant (PDA), a mobile computer, and the like.

Although certain embodiments have been shown and described, it is understood that equivalents and modifications falling within the scope of the appended claims will occur to others who are skilled in the art upon the reading and understanding of this specification.

1. A method of controlling a display of a portable electronic device, the method comprising:
retrieving data which are indicative of a temperature variation over the display;
processing the retrieved data to generate a temperature chart for the display, the temperature chart being indicative of a temperature profile which is spatially varying in a display plane; and
controlling the display in a spatially varying manner in accordance with the generated temperature chart.

2. The method of claim 1,
wherein controlling the display comprises applying a color correction to compensate for temperature-induced color alterations, the color correction being spatially varying in accordance with the generated temperature chart.

3. The method of claim 2,
wherein the color correction is applied to image data to generate temperature-compensated image data based on both the generated temperature chart and the image data, and
wherein the display is controlled to output the temperature-compensated image data.

4. The method of claim 2,
wherein the retrieved data indicative of the temperature variation comprise temperature data for a plurality of areas of the display, the plurality of areas being offset from each other parallel to the display plane.

5. The method of claim 2,
wherein the retrieved data indicative of the temperature variation comprise temperature data for at least one region of the display and information on a topology of the portable electronic device.

6. The method of claim 5,
wherein the information on the topology includes information on a position of at least one electronic component of the portable electronic device relative to the display.

7. The method of claim 5,
wherein temperature data for a plurality of regions of the display are determined based on the information on the topology of the portable electronic device and the temperature data for at least one region of the display.

8. The method of claim 4,
wherein the temperature chart includes an estimate for a temperature at another region of the display for which no temperature data are retrieved.

9. The method of claim 2,
wherein the retrieving and processing operations are repeated after a time interval to generate an updated temperature chart, and
wherein the color correction is dynamically adjusted in accordance with the updated temperature chart.

10. The method of claim 9,
wherein the method further comprises:
monitoring a workload of at least one electronic component of the portable electronic device, and
adjusting the time interval based on the workload.

11. The method of claim 2,
wherein the display has a plurality of pixels, each pixel having a color value, and
wherein the color correction which is applied to the color value of a pixel is set based on a value of the temperature chart for the respective pixel.

12. The method of claim 1, further comprising:
sensing, by a thermistor array, the data indicative of the temperature variation.

13. A portable electronic device, comprising:
a display; and
a controller coupled to the display, the controller being configured to
retrieve data which are indicative of a temperature variation over the display;
process the retrieved data to generate a temperature chart for the display, the temperature chart being generated so as to be indicative of a temperature profile which is spatially varying in a display plane; and
control the display in a spatially varying manner in accordance with the generated temperature chart.

14. The portable electronic device of claim 13, further comprising:
a thermistor array configured to sense the data indicative of the temperature variation,
the controller being coupled to the thermistor array to retrieve the data indicative of the temperature variation from the thermistor array.

15. The portable electronic device of claim 13,
the controller being configured to apply a color correction to compensate for temperature-induced color alterations, the color correction being spatially varying in accordance with the generated temperature chart.

16. The portable electronic device of claim 13,
the controller being further configured to
apply a color correction to image data to generate temperature-compensated image data based on both the generated temperature chart and the image data, and
control the display to output the temperature-compensated image data.

17. The portable electronic device of claim 13,
wherein the retrieved data indicative of the temperature variation comprise temperature data for at least one region of the display and information on a topology of the portable electronic device, the information on the topology including information on a position of at least one electronic component of the portable electronic device relative to the display.

18. The portable electronic device of claim 13,
the controller being further configured to
to monitor a workload of at least one electronic component of the portable electronic device, and
adjust a time interval at which generation of the temperature chart is repeated in dependence on the workload.
